(19) United States
(12) Patent Application Publication
(10) Pub. No.: US 2024/0428245 A1
(43) Pub. Date: Dec. 26, 2024

(54) DEVICES AND PROCESSES FOR PRODUCING DIGITALLY IMAGED SUBSTRATES

(71) Applicant: Gogigit, LLC, Mt. Pleasant, SC (US)

(72) Inventors: Ming Xu, Malvern, PA (US); Dimple Patel, Mt. Pleasant, SC (US)

(73) Assignee: Gogigit, LLC, Mt. Pleasant, SC (US)

(21) Appl. No.: 18/828,701

(22) Filed: Sep. 9, 2024

Related U.S. Application Data
(63) Continuation-in-part of application No. 17/528,458, filed on Nov. 17, 2021.

(51) Int. Cl. G06Q 20/40; G06Q 20/38; H04L 9/08

(52) U.S. Cl. CPC G06Q 20/4014; G06Q 20/382; H04L 9/0825

(57) ABSTRACT

A system for producing digitally imaged goods comprises a central computing device for storing and encrypting digital images that communicates with a plurality of geographically separated computing systems, with each of the geographically separated computing systems controlling one or more image forming devices that form digital images on a product substrate to produce the goods. Enhanced security protocols, including blockchain-based ledgers and hardware security modules, ensure the protection and integrity of digital assets throughout the production process. Image forming devices (imaging devices) that are useful for forming digital images on a product substrate are selected from inkjet and laser printers, engravers, cutters and other imaging devices that respond to digital inputs.

This Application is a continuation in part of application Ser. No. 17/528,458, filed Nov. 17, 2021 upon which Applicant claims priority.

### FIELD OF THE INVENTION

The invention relates to the production of custom imprinted goods and is more specifically directed to a system for storing digital images and transmitting digital images by secure protocols to one or more geographically separated computing systems as selected by a computing device, the geographically separated computing systems, having associated imaging devices.

### BACKGROUND OF THE INVENTION

Digital technology allows for mass customization of goods. High volumes of articles may be imaged (“mass”), with each article potentially having a different image (“customization”). Single articles or low volumes of objects may also be economically customized using digital imaging methods. There is a need for a mass customization network for the production of imaged goods having enhanced security protocols.

### SUMMARY OF THE INVENTION

A system for producing digitally imaged goods is disclosed. The system comprises a central computing device (CCD) for storing and encrypting digital images. The central computing device communicates with a plurality of geographically separated computing systems, with each of the geographically separated computing systems controlling one or more image forming devices that form digital images on a product substrate to produce the goods. Enhanced security protocols, including blockchain-based ledgers and hardware security modules (HSMs), ensure the protection and integrity of digital assets throughout the production process.

The devices and processes for producing digitally imaged goods may include enhanced security protocols. A blockchain-based ledger for recording transactions and quality control information may be incorporated. The invention may further incorporate additional security measures, including but not limited to Hardware Security Modules (HSMs), Trusted Platform Modules (TPMs), and Fast Identity Online (FIDO) authentication devices, to ensure the protection of digital assets and the integrity of the production process. Image forming devices (imaging devices) that are useful for forming digital images on a product substrate are selected from inkjet and laser printers, engravers, cutters and other imaging devices that respond to digital inputs and are employed according to the substrate to be imaged.

### BRIEF DRAWING DESCRIPTION

FIG. 1 illustrates an example of an image created by an artist or digital graphic image designer.

FIG. 2 is an illustration showing exemplary elements of a geographically separated computing device, including a product image forming device that is a computer-controlled printer and a heat press.

FIG. 3 depicts major components of a networked product imaging system.

FIG. 4 is a flowchart showing an example of the workflow for a digital imaging production process.

FIG. 5 illustrates communications and devices for implementing management and interfacing functions of a digital imaging production process.

FIG. 6 shows an example of a producer's geographically separated digital imaging device communicating through an imaging ledger gateway.

FIG. 7 shows a customer or client's computing device communicating with the networked product imaging system.

FIG. 8 is a system architecture diagram illustrating the integration of Hardware Security Modules (HSMs), Trusted Platform Modules (TPMs), and FIDO authentication devices within the digital imaging production management system.

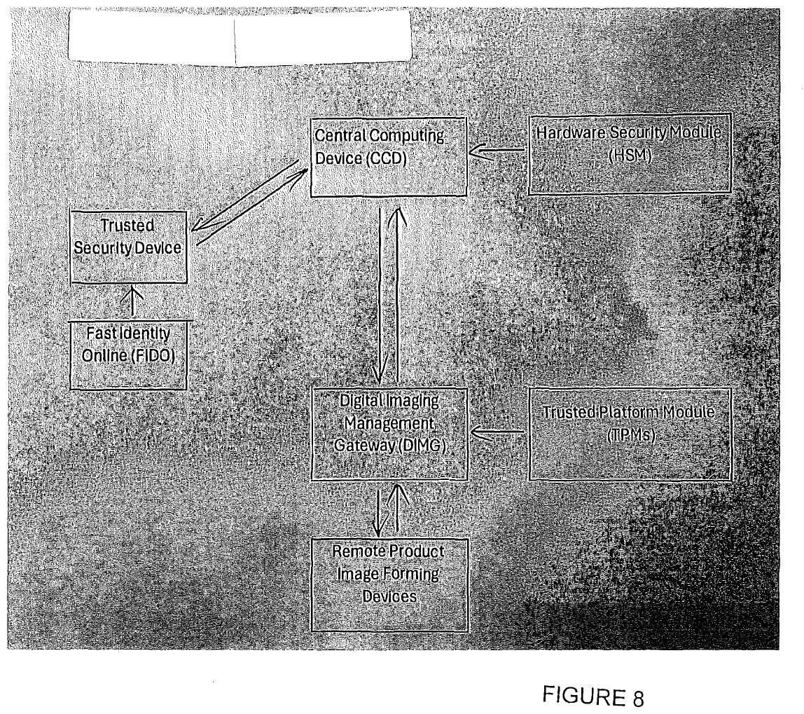

FIG. 9 presents a secure hardware integration flowchart demonstrating how the new secure hardware modules are incorporated into the digital imaging production process.

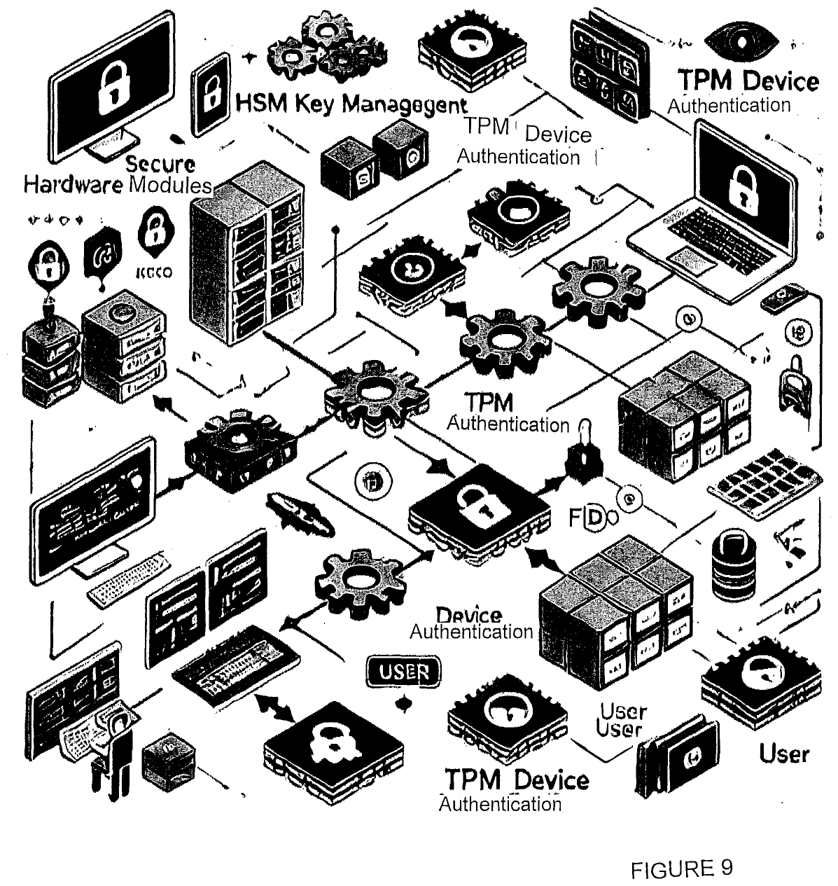

FIG. 10 depicts a key management hierarchy diagram visualizing the structure of key management involving HSMs, TPMs, and FIDO devices within the system.

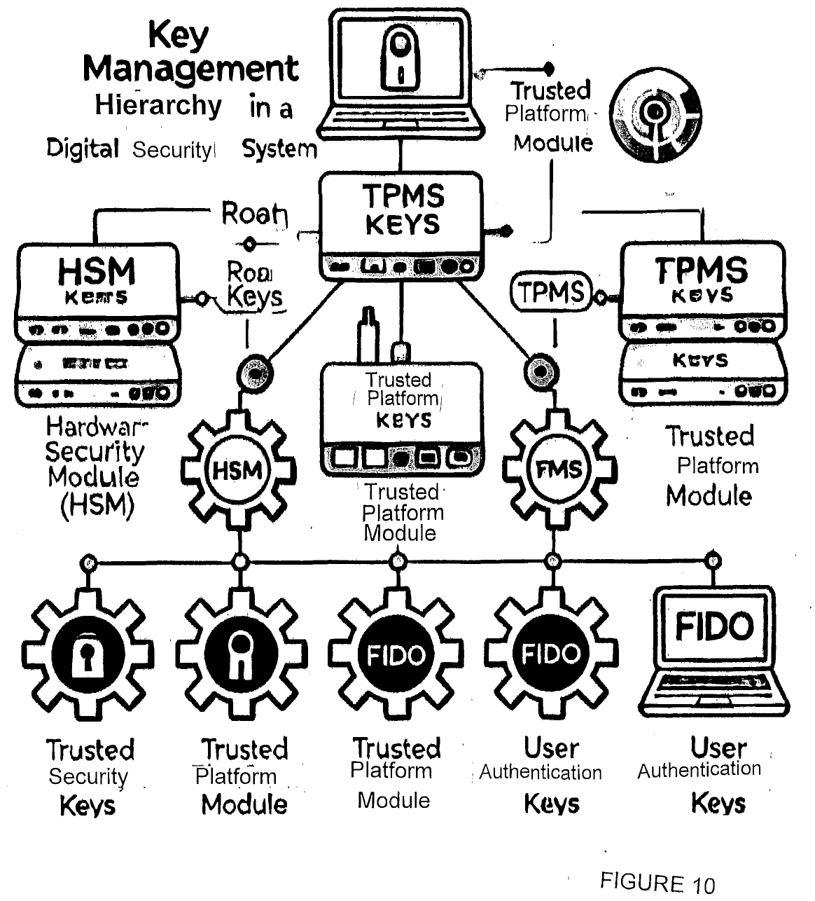

### DESCRIPTION OF PREFERRED EMBODIMENTS

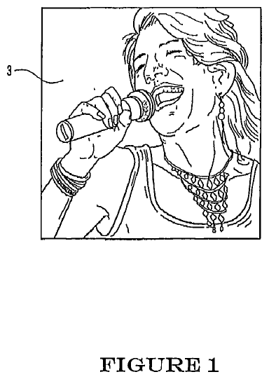

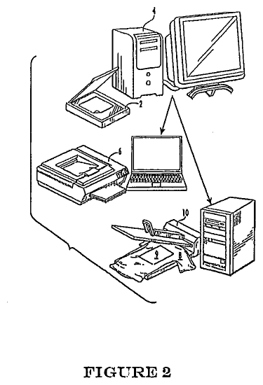

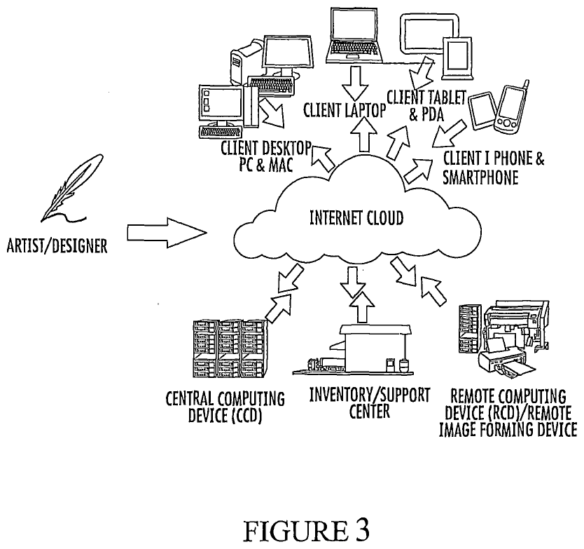

A digital image (FIG. 1) is created by artist, author or image designer. The digital image is reproducible in tangible form on substrates by a digital imaging device (FIG. 2). The system permits customization of various substrates at locations that are geographically separated from a central computer that stores the digital image. FIG. 3 illustrates an example of custom product production comprising an original digital image provided by an artist or designer. In one embodiment of the present invention, participants in the digital imaging production process are connected to a central computing device, such as by an internet/cloud connection. The system produces customized goods that display original images that are digitized using cloud based graphic design tools and geographically separated imaging systems.

An artist's original image is provided to a central computing device. The original image is in a digital form or is digitized, and is encrypted. A modified version of the digital image is publicly accessible to potential purchasers, such as by displaying a modified version of the digital images on a networked e-commerce platform. A purchaser may review modified versions of multiple digital images on the networked e-commerce platform prior to selecting the digital image from the digital image to be produced on a selected substrate to produce the imaged product.

A geographically separated producer of imaged goods receives an order from a customer who desires to purchase a product with the original digital image displayed. The producer orders the image from the central computing device. The central computing device verifies that a number of images allocated for production has not been exceeded, and if not exceeded, provides the image to producer who is provided with a key to decrypt the image. The producer produces the image on a product. The artist is compensated for use of the image.

Security protocols verify that subsequent distribution of the image does not occur on an unauthorized basis. Encryption keys facilitate the production of imaged goods at geographically separated locations while protecting the digital assets of participants. An image ledger gateway controls encryption keys in connecting selected images to geographically separated imaging systems. The images are accounted for, and quality information is monitored by the immutable ledger. Original designs are encrypted and can only be decrypted by authorized entities, such as manufacturers or producers. The digital designs and primary elements thereof are tracked, such as by an immutable distributed ledger, which may be a blockchain ledger bundle in one embodiment. This tracking occurs throughout the ordering and production process, ensuring that only authorized reproduction occurs. Payment flow is recorded and secured.

In one embodiment, a smart print driver or other smart driver of an imaging device validates against data provided to verify a right to print or form the image. The driver validates against the number of authorized allocations of an image to ensure that the authorized number of allocations has not been exceeded. The driver may validate that it has not previously formed the image. The print driver or other driver of an imaging device may validate that it has been authorized to print or form the image and that it is authorized to print or form the image according to data for certain print specifications. Examples of such specifications include image colors, image size, product substrate, and image location on the substrate. Other data that the smart driver may validate includes the customer's name, the origin of the order, and payment. Specifications may be provided by an artist, a customer, or a producer. Validation feedback is provided from the driver to a point of origin, such as to the CCD.

Quality control information is recorded and secured by the use of a ledger bundle to ascertain immutable status and traceability throughout the entire imaging process that involves participants having various roles, including imaging equipment companies, substrate providers, substrate, and consumable suppliers, and others. Authorized and authentic materials and consumables with verifiable data are maintained.

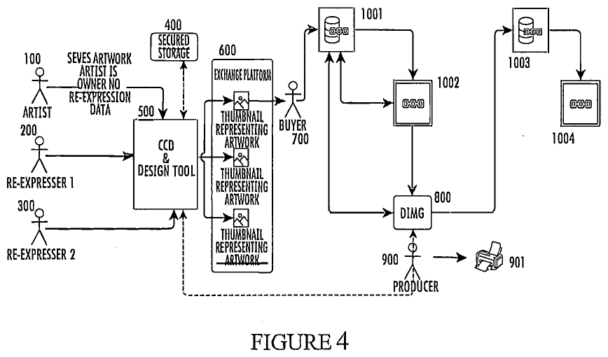

Turning to the illustrations, an artist or designer 100 creates original artwork, either in digital form or by digitizing artwork created in another form, and sends the original artwork to a secured cloud storage database 400 associated with a central computing device (CCD) 500 (FIG. 4). The CCD encrypts the artwork image and, in one embodiment, creates a set of asymmetric cryptographic key pairs, one public and one private. The encryption-protected image is presented at an exchange portal 600, which may be publicly accessible and viewable. The image may be presented as an icon having a low resolution and presenting insufficient visual detail and quality to permit the generation of a commercially useful imaged product.

The secured cloud storage database 400 may be employed to store multiple types of objects. The CCD 500 in this embodiment has access to the database 400, allowing it to be used for internet applications, backup and recovery, disaster recovery, data archives, data lakes for analytics, and hybrid cloud storage. The storage may be divided into units or buckets, and each unit or bucket can be protected by unique and user-defined keys for access control. A programmable software development kit (SDK) and application program interface (API) may be available for the CCD 500 and customer/buyer to develop specific access and software access needs. The content of storage units may be downloaded using the HTTP GET interface and the BitTorrent protocol, which are protocols for cloud storage access.

A key management system (KMS) may be installed at cloud storage database 400, allowing the central computing device (CCD) 500 to create, import, rotate, delete, and manage user permissions on cryptographic keys, often asymmetric key pairs, by using an SDK, command-line interface (CLI), and/or various APIs. Digitally signing operations that use asymmetric key pairs to ensure data privacy and integrity may be included in the control and communication tools at cloud storage database 400.

Though both vector and bitmap image types may be used, image files of various formats created by the artist or image designer may be loaded to the cloud storage database 400, including TIFF/TIF, PNG, JPEG/JPG, GIF, and other formats. High-quality image file types, such as PNG, with both grayscale and RGB color features, 8-bit color quality or better, and with a transparency option for further modification, are preferred. Lossless compression of images during internet transmission is also desirable. Preferred final (ready-to-print) and fully rendered composite image file types include PNG and PDF.

A customer or an image purchaser/buyer 700 enters the imaging network and obtains a public key, assigned by CCD 500, allowing access to the image and producing in-network participation information, such as digital ID, digital wallet ID, and payment information. If purchasing of an image occurs, a distributed ledger or blockchain transaction ledgering process is initiated in one embodiment that is based on predefined bundle protocol or smart contract/chaincode 1001. If validation of purchase and payment is confirmed, and a permitted number of copies of the imaged product is confirmed, a producer ID and a countdown number are generated, for example, at a blockchain smart contract or chaincode control 1002. A private key to decrypt the purchased product design will be assigned and communicated to the assigned producer. The private key is suitable to generate a technology-specific form of the image that can be reproduced on a product. The network digital imaging management gateway (DIMG) 800 communicates with the corresponding producer 900 by an authorized digital imaging device 901 to produce the permitted quantity limit of imaged goods having a particular custom or original image on the substrate. Information throughout the process is bundled with different transactions and permanently written in chain block 1004 through assigned protocols or smart contract/chaincode content 1003. Producer 900, upon finishing the product manufacturing process, communicates with CCD 500 and continues with the next imaging job in the queue.

The network central computing device (CCD) 500 communicates with a plurality of geographically separated product image forming systems 901 through the digital imaging management gateway (DIMG) 800. These systems belong to different producers 900 with various technologies. For instance, various types of digital inkjet printers, 3D printers, embroidery machines, digital presses, cutter/contour-cutter/kiss-cutters, digital doming machines, digital laser ablation equipment, engraving machines, and the like are used for imaging goods with the original artwork. These imaging devices 901 can be identified, either directly or indirectly, with a digital identification number or serial number. Materials used with these devices, such as ink, toner, thread, output energy, and/or blank substrates, can be identified, quantified, recorded, and communicated with DIMG 800 as permanent blockchain content.

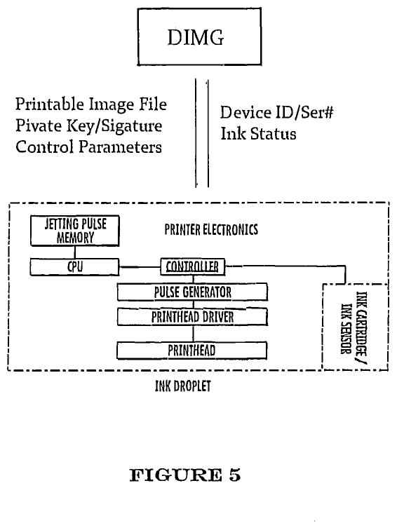

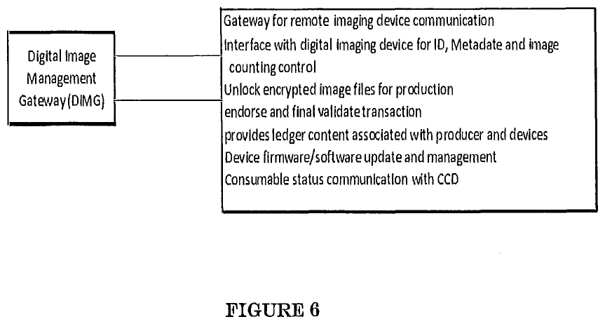

FIG. 5 illustrates an example of data communication between DIMG 800 and an inkjet printer. A printable image file is transmitted from the DIMG to an inkjet printer upon being decrypted with a private key provided by CCD 500 after confirming the transaction and the number of prints. Also transmitted are device parameters and/or instructions to ensure that the correct digital images are produced with quality inks, toners, substrates or materials and by the required procedures to achieve the required image and product quality standards. Printer identification and/or serial number information, and inkjet ink status, such as batch number and/or consumption levels, may be transmitted back to DIMG 800 as transaction data stored in the immutable digital ledger or chain blocks. FIG. 6 further defines the functionality of DIMG 800.

In the embodiment shown in FIG. 6, the Digital Imaging Management Gateway (DIMG) 800 is a computational gateway, or server, which accepts the private key(s) from designated producers to unlock encrypted and blockchain-protected imaging files or metadata. These keys are authorized and communicated from the central computing device (CCD) 500 to authorized producers who have validated purchase confirmation and/or payment confirmation from a customer or consumer. An authorized number of copies of the image, as assigned and included in the content of the smart contract or chaincode, is verified according to decrement counting at DIMG 800, which is connected with the producer's (900) geographically separated imaging device(s) that produce the imaged goods.

In one optional embodiment, the present invention uses product producers' 900 unique imaging device 901 identifications, or some of them, as the private cryptographic keys instead of generating random number codes. These keys are regulated by the key management system (KMS), stored at cloud storage database 400, and verified through DIMG 800 for corresponding product producers 900 with designated product manufacturing orders.

Different encryption or hashing methods, algorithms, or techniques may be used to generate cryptographic keys. Techniques such as MD5, SHA-2, and/or CRC32 may be used as long as no ‘hash collision’ occurs. An imaged product producer 900 can access a job order only with matching private cryptographic key(s) embedded in the metadata file(s) before the actual imaged product can be produced by the corresponding device 901.

In order to connect to and communicate with different constructs of imaging systems 901 at various separate and geographically separated locations, DIMG 800 may include function-specific middleware and/or API so that imaging data/metadata files can be transmitted from DIMG 800 and understood by imaging systems 901. The middleware and/or API, especially local APIs, ensure information related to production is properly sent from devices 901 and understood by DIMG 800, and is included in the content of smart contract/chaincode for transaction verification purposes and/or storage at CCD 500/secured cloud storage database 400. For example, a printer driver specifically designed for a digital inkjet printer located at DIMG 800 sends printable Printer Command Language (PCL) files to the printer 901 along with control parameters such as ink limiting, color profiles, ink dot gain control lookup tables, etc. for the inkjet printer to execute, while also allowing DIMG 800 to collect information such as the number of hardcopies produced, the ink manufacturer identification, the ink usage level, the ink batch number, and the like. This information represents important quality control information that is available for product quality control, quality assurance, and customer support. Including this information as part of the blockchain or ledger content is preferred.

In an embodiment of the present invention, a permitted blockchain system or platform is used for the custom imaging production network. In some embodiments other types of security frameworks having condition-based smart contract or chaincode algorithms may be used. Practical Byzantine Fault Tolerance (PBFT) consensus modified PBFT consensus, Redundant BFT, Q/U, PBFT with Hyperledger framework such as Hyperledger Fabric, Hyperledger Sawtooth, Iroha, Burrow, and Hyperledger Indy protocols or consensus may be adapted for the application of the present invention. Cryptographic tokens are optional for the present invention.

A framework that may be used in the present invention involves establishing permissible quantities of secondary participating peers or nodes for transaction consensus validation and distributed ledger keeping. These nodes may represent artists, producers, sellers, consumable material suppliers, or other network participants having the need or ability to participate in the networked e-commerce platform. Historically high volume transaction participants may have status as high engagement contributors and given higher priority in receiving images or production jobs. This rule is designated Proof-of-Engagement, indicating the basic peer/node selection principle of this invention. For instance, a producer may consume a large amount of imaging consumables within the network and is given a high ‘engagement’ ranking for producing imaged goods and is therefore categorized as a trustworthy blockchain framework peer/node member. Similarly, an artist creates a high volume of images that are selected for production of imaged goods, and therefore creates a high volume of network transaction flows, may also be given a high ‘engagement’ ranking as a participating peer/node.

To prevent or reduce unnecessary consensus computational tasks, and to prevent or reduce peer/node system failures, the security framework of the present invention limits its secondary peer/node, or consensus voting, participation. Preferably, the number of secondary peers/nodes is more than 4 and less than 200, and most preferably between 4 and 50. The list of participants may be renewed/changed from time to time, or upon achieving certain transaction blocks based on revised ranking of high engagement participants.

To further decrease system failures due to computing system latency, local network high traffic occurrences, or mass geographic web communication downtimes, the selection of participating peer or node members may include members from different continents, counties, regions or widely geographically separated areas or jurisdictions. A combination of Domain Name System (DNS) or internet root zones may be selected to form the final consensus forming the blockchain peer/node group.

Central computing device (CCD) 500 is a preferred primary peer or node of the permissioned security framework. It communicates with all other peers or nodes by first broadcasting a transaction request from a customer or client. It also acts as one of the voting peers or nodes to obtain validation of a transaction and a distributed ledger or blockchain creation process. CCD 500 grants or revokes a participants' status as peer/node, and is responsible for maintaining communications, including transaction protocol communications among network participants.

Customer or client 700 or no or low engagement ranking participants, including but not limited to low engagement producers, sellers, blank material providers, may obtain a Simplified Payment Verification (SPV) status, or designated as ‘light-clients’ of the system. These SPV/light-client participants may be able to only download the header portion of ledger blocks during the initial application installation and network synchronization process. Transactions and access from full nodes can be requested and granted by CCD 500 when needed. This arrangement decreases unnecessary data flow at the bundled network and provides increased security and confidentiality for other participants.

Commercially distributed ledgers such as provided by commercial blockchain services may be integrated into present invention in place of CCD 500 in an independently hosted blockchain framework. Blockchain-as-a-Service (BaaS), Blockchain Technology-as-a-Service (BTaaS) of different kinds can be linked to central computing device (CCD) 500 and perform the previously defined functions, transaction control and validation, information gathering and recording, together with other functions that the CCD 500 performs.

Transaction and/or payment methods that may be used in the present invention may include traditional or conventional methods including credit cards, electric wire transfers, such as the Society for Worldwide Interbank Financial Telecommunications (SWIFT), in-chain cryptographic tokens, or other methods acceptable to participants. Transactions can be tracked and recorded by the blockchain system for validation and historic analysis purposes. Transactions with external blockchain ecosystems may be developed using cross-chain technologies by using similar transaction payment methods. For instance, FabToken, a cryptocurrency management system, may be adapted for both in-chain and cross-chain transaction payment purposes if, for example, the Hyperledger Fabric v2.0 ecosystem is used in the current invention. Another example is COSMOS cross-chain tools used for inter-blockchain communication protocols and transfer of tokenized payments with external blockchain systems.

The present invention, in yet another embodiment, provides cloud or web-based user interface (UI) and graphic design tools for buyers/customers to modify or customize artwork images downloaded from cloud storage after decryption using local computing devices, such as laptop computers or smart mobile devices. For example, a combination of the image with other designs may provide a more personalized customer product. Uploaded photographs, added images and/or text information can be added to the original image using graphic design tools before the final image is sent to an imaging production device via DIMG 800. Variable data customization image production with multiple images having different text information, such as name or identity, can be spooled, queued, and finally produced by the imaging device. In-cloud temporary storage, either at or through central computing device (CCD 500), may be provided during the graphic modification or supplementation process.

The graphic design tool set of the present invention, through the use of web or cloud-based user interfaces, allows a buyer to modify purchased digital designs by adding customized or personalized features and/or effects to the purchased digital designs. An image design template with multiple-layer structure feature permits the purchased artwork to be used as either background, forefront, middle layer insert, or even artistically masked with other image layer(s) with various opacities or transparencies. The purchased artwork or artworks may be locked as an independent layer which cannot be changed, distorted, or modified in shape, color, ratio, and may not even to covered for portion(s) with copyright identified and claimed areas or features.

In one embodiment, the creator of the digital image defines a layer or a plurality of layers of the digital image as proprietary to the creator. Each layer of the layer of the plurality of layers that is defined as proprietary to the creator may be separately encrypted with a public key that is unique to the layer. The central computing device will allocate a portion of the payment for the imaged substrate that comprises a layer or plurality of layers defined as proprietary. Depending on the imaging technology, substrate properties, substrate dimensions and shape, and final product properties, the design template or templates may automatically resize the purchased artwork before overlaying or superimposing the artwork with other customized design features. This capability ensures that the purchased artwork is shown in its entirety on the final imaged product, but with dimensions, shape, and contours suitable to the selected substrate. Graphic design creation, modification and/or manipulation techniques may also be used. For example, cropping, filtering, shaped and/or geometrically shaped masking, image-in-text, and/or opacity changes can be included in the design template for better visual and text message effects. A final composite image can then be generated and sent to the imaged product producer as part of the production order specifications.

An original design may be sequentially modified by subsequent users if permitted by prior users or artists. Users who provide modifications along the chain may be awarded a portion of the sales price if their modification is used by a subsequent user.

Artists may wish to limit the number of copies of their work that may be produced. The network imaging ecosystem of the present invention provides the ability to limit and control the number of copies of imaged goods buyers/customers 700 are able to purchase. FIG. 4. When a purchase is made, a defined number of copies of imaged goods decorated with the decrypted artwork image is locked and bundled with the distributed ledger or blockchain ledger through smart contract or chaincode. The Digital Imaging Management Gate (DIMG) 800 executes a decrement process, reducing the count of available images each time a single imaging data file is sent to geographically separated imaging device 901. DIMG 800 further determines the number of imaging allocations remaining for the selected and purchased digital image. Only when a non-zero count for the remaining image allocations for the purchased digital image is available will DIMG 800 transmit the requested image file from CCD 500 to allow production of product imaged with the purchased image.

Different substrate materials may be used with the present invention. This allows goods formed of different materials to be imaged according to the invention. Examples may include textile, metal, wood, ceramic, polymer, plastic or resinous materials, glass, etc. Depending on the imaging method or technology, direct or indirect (such as transfer) imaging forming methods may be used. Extra steps may need to be taken for indirect imaging methods. Instructions for operations may be included in the metadata file provided by DIMG 800 to the geographically separated producer 900 and/or devices 901.

The image infringement/theft prevention processes described herein may be used in conjunction with graphic re-work tools and immutable ledger/distributed or blockchain networks. The invention reduces unauthorized copying, download, screenshot, hot-linked representation, illegal web-scraping and the like, further protecting the interests of both the artist/designer and consumer. For instance, embedding a plug-in program of WordPress' Copy Content Protection may disable certain mouse and keyboard commands, thereby preventing local printing, or captioning of either an on-screen image and/or text information.

The invention allows buyers, clients, customers, sellers, substrate suppliers, and other imaging network participants 200 to endorse artists and designers and their images and artwork. For instance, after a buyer purchases certain artwork and likes the design, he or she may post his/her endorsement through ‘re-expression,’ which will increase the corresponding artist or image designer's work rating. (FIG. 4) The higher the ‘re-expression’ count, the higher the transaction rate of certain artwork may be reflected. Other non-transaction participants 300 may also be involved in ‘re-expression’ endorsement. Artists or image designers who receive high ‘re-expression’ endorsement may be elevated to high Proof-of-Engagement status.

An original design can be sequentially modified, or “re-expressed”, by subsequent users if permitted by prior users. Users who provide modifications along the chain may be awarded a portion of the sales price if their modification is used by a subsequent user.

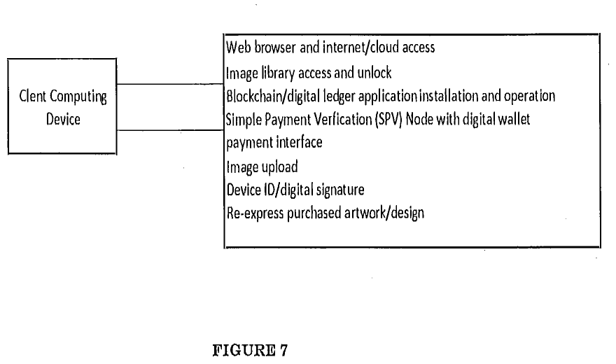

FIG. 7 depicts basic software functions and computational capabilities of buyer or client computation devices. Such requirements ensure improved access and use of the network for imaged product purchase, decryption, image uploading, graphic design interfacing, payment, and re-expression endorsing exercises. Operating systems that may be used include Microsoft, Linux, or Apple OS X, Android, Apple IOS.

A buyer or client 700 of the secured imaging network of the present invention may tender his or her payment following the blockchain protocol to CCD 500 for the purchase of both the artwork/design and the cost of the imaged product. Payment to imaged product producer 900 and artist 100 is transferred, such as from CCD 500, according to the blockchain protocol. Transactions are sequenced and recorded in the chain blocks with time stamps.

In another embodiment of the invention for producing digitally imaged goods, the plurality of digital images is stored in a database and encrypted with a public key that is unique to each digital image as described above. A selected digital image from the plurality of digital images is decrypted by a private key assigned to an imaged product producer. A driver of an imaging device controlled by the imaged product producer validates data associated with the selected digital image, and upon validation of data associated with the selected digital image, the imaging device images the imaged substrate with the selected digital image to produce the imaged substrate. The driver of the imaging device controls allocation of the payment for the imaged substrate imaged with the selected digital image, including allocation of the payment to one or more creators of the selected digital image.

The imaged product producer may control multiple imaging systems and their devices with a single private key that is assigned to the image product producer. This permits the imaged product producer to assign an imaging job to any one of multiple imaging devices, rather than being limited to assignment of the imaging job to a specific imaging device associated with one specific private key.

In an example, of a system for producing digitally imaged goods a central computing device communicates with a plurality of geographically separated imaging systems. Each geographically separated imaging system comprises a computing device that has an associated digital imaging device, which may be a digital printer, an engraver, a cutter or other digital imaging devices. The central computing device is constructed and arranged to select a geographically separated imaging system from a plurality of geographically separated imaging systems based upon properties of an image to be produced on a final substrate and a location and capability of the geographically separated imaging system to produce the image on the substrate. The digital image is encrypted with a key that is unique to the digital image and is associated with a private key assigned to the selected geographically separated computing system.

The system may print inks that are heat sensitive, such as inks or toners comprising sublimation dyes. The images formed from heat sensitive inks may be heat fixed or heat transferred to a final substrate. The final substrates according to the invention may include, but are not limited to useful articles formed textiles or polymers, but do not include paper.

In yet another embodiment, the present invention employs additional security measures, including but not restricted to Hardware Security Modules (HSMs), Trusted Platform Modules (TPMs), and Fast Identity Online (FIDO) authentication devices. These components are integrated into the digital imaging production system to enhance security and protect against unauthorized access and tampering.

Hardware Security Modules (HSMs): HSMs, such as the nShield HSMs from nCipher Security (now part of Entrust) and Luna HSMs from Thales Group, securely store and manage cryptographic keys. They provide an isolated environment for executing cryptographic operations, such as key generation, encryption, and digital signatures, ensuring that sensitive key material is never exposed in plaintext. HSMs also feature physical tamper-resistant mechanisms and secure boot processes, further enhancing the system's security.

Trusted Platform Modules (TPMs): TPMs, such as the Infineon SLB 9670 TPM2.0 and STMicroelectronics ST33TPM12LPC, are secure cryptoprocessors integrated into geographically separate devices. They provide key functions such as device authentication, secure storage of credentials, and attestation of device integrity. TPMs establish a chain of trust from the HSM to each device, ensuring the authenticity and integrity of all transactions and communications within the system.

Fast Identity Online (FIDO) Authentication Devices: FIDO devices, such as the Yubico YubiKey 5 NFC, are hardware-based multi-factor authentication tools that enhance user security. They use public key cryptography to eliminate the risks associated with shared secrets, such as passwords, and provide phishing-resistant authentication. FIDO devices are often integrated with biometric sensors to further secure user access to the system, making them highly effective in both professional and consumer environments.

The integration of FIDO authentication is particularly significant in the context of customer interactions with the system, such as when a purchaser orders an imaging product from a smart device like a smartphone. Modern smartphones often support FIDO authentication through built-in biometric sensors, such as fingerprint scanners or facial recognition, or by connecting with external FIDO devices, such as a YubiKey, via USB or NFC. This enables the customer to authenticate securely and conveniently without the need for complex passwords. For instance, during the purchase process, the customer can use the smartphone's biometric sensor to generate a secure, device-specific key pair. The public key is sent to the server, while the private key remains securely stored on the smartphone. This method ensures that even if the smartphone is compromised, the private key is never exposed, maintaining the integrity and security of the transaction. The seamless integration of FIDO with smart devices enhances both security and user experience, making the system accessible and secure for a broad range of users.

The following user case examples illustrate the application of these security measures:
User Case Example 1: Digital Image Encryption—An artist uploads a digital image to the Central Computing Device (CCD), where it is encrypted using the HSM (e.g., nCipher nShield Solo). This encryption process ensures that the digital image is securely stored and can only be accessed by authorized entities. The image is then transmitted to a geographically separated imaging device, where the TPM (e.g., Infineon SLB 9670 TPM2.0) verifies the device's integrity before allowing the image to be decrypted and printed. This step ensures that the image is securely handled throughout the process, protecting both the artist's intellectual property and the quality and integrity of the final product.
User Case Example 2: User Authentication-A producer attempts to access the system using a FIDO device (e.g., Yubico YubiKey 5 NFC). The system prompts the producer for authentication, which is conducted through the FIDO device's biometric authentication or by connecting the device to the smartphone via USB or NFC. The system then validates the user's credentials using the HSM, ensuring that only authorized personnel can initiate the production process. The FIDO device's integration with biometric sensors adds an additional layer of security, preventing unauthorized access and ensuring that all actions taken within the system are authenticated and traceable.

The secure hardware modules work together to create a cohesive and robust security infrastructure. The HSM at the central computing device (CCD) serves as the root of trust, managing root keys and performing high-security cryptographic operations. TPMs in geographically separated imaging systems handle device-specific keys and ensure the integrity of each production endpoint. FIDO devices manage user authentication keys, providing secure access for producers and other authorized personnel.

A hardware-based key hierarchy is implemented, where the HSM manages root keys, TPMs handle device-specific keys, and FIDO devices manage user authentication keys. A custom secure communication protocol leverages the unique capabilities of each hardware component to ensure end-to-end security in all system interactions.

The integration of these secure hardware modules enhances the blockchain-based security framework. The HSMs provide hardware-based support for the cryptographic operations required by the blockchain, while the TPMs ensure the integrity of the participating nodes. FIDO authenticators add an additional layer of security for user access to the blockchain network.

The secure hardware modules also enhance the quality control and traceability aspects of the system. The TPMs in the imaging devices can provide cryptographic proof of the device's configuration and state during production, which can be recorded in the blockchain as part of the product's provenance. This creates an immutable record of the production process, further ensuring the authenticity and quality of each produced item.

In the context of blockchain operations, the system implements a robust Proof-of-Engagement (PoE) principle to determine the trustworthiness and reliability of participants within the digital imaging production network. The PoE principle is a consensus mechanism designed to evaluate and validate the engagement level and commitment of network participants based on their interactions, security practices, and contributions to the network's overall integrity.

The PoE mechanism assesses various metrics that reflect the quality and authenticity of each participant's contributions. These metrics include:
Consistent Use of FIDO Authenticators: The frequency and consistency with which a participant employs FIDO authentication devices, such as the Yubico YubiKey 5 NFC, is a key metric in the PoE evaluation. Regular use of FIDO devices indicates a participant's adherence to high security standards, reducing the likelihood of unauthorized access and ensuring that all actions within the system are properly authenticated.
Integrity of TPM Measurements: The Trusted Platform Modules (TPMs) embedded in geographically separated imaging systems provide cryptographic proof of each device's configuration and state during production. The PoE principle considers the accuracy and reliability of these TPM measurements, which help verify that devices are operating within expected parameters and have not been tampered with. Consistent, verifiable TPM measurements enhance a participant's engagement score by demonstrating their commitment to maintaining a secure and trustworthy environment.
Compliance with HSM-Based Cryptographic Operations: The Hardware Security Modules (HSMs) deployed within the system serve as the root of trust for all cryptographic operations. The PoE principle evaluates a participant's compliance with the secure storage and management of cryptographic keys via HSMs. Participants who consistently adhere to HSM protocols, such as key rotation and secure key storage, contribute positively to their engagement ranking.
Contribution to Network Security: Beyond individual security practices, the PoE principle also considers a participant's contributions to the overall security and robustness of the network. This includes reporting vulnerabilities, participating in security audits, and actively engaging in the continuous improvement of the system's security protocols. Participants who demonstrate proactive involvement in enhancing network security are rewarded with higher engagement scores.

The combination of these metrics allows the PoE principle to create a dynamic, tamper-resistant engagement ranking system that reflects the true commitment and reliability of each network participant. This ranking influences not only the level of trust accorded to each participant but also their access to certain network privileges, such as priority in transaction processing, access to premium resources, and participation in governance decisions within the network.

By incorporating the PoE principle, the digital imaging production management system ensures that participants are incentivized to maintain the highest standards of security and integrity. This, in turn, fosters a more secure, reliable, and transparent network, where trust is earned through demonstrable engagement rather than mere participation.

The hardware-based security infrastructure is designed with scalability in mind. As the network of producers and imaging devices grows, additional HSMs can be deployed in a hierarchical structure to manage increased cryptographic workloads. The modular nature of TPMs and FIDO devices allows for easy integration with new imaging devices and user authentication systems, respectively.

The enhanced security measures provided by this system have far-reaching implications for the digital imaging industry. These measures increase trust in digital asset management, encouraging more artists and designers to participate in digital distribution channels. They also improve protection against counterfeiting and unauthorized reproduction of digital images, including the protection against unauthorized imaging consumables or substrates, enhance traceability for quality control and warranty purposes, and have potential applications in other fields requiring secure digital asset management, such as 3D printing, digital manufacturing, and customized product industries.

While the hardware-based security measures significantly enhance the system's protection against various threats, further steps may be implemented. Regular security audits of the entire system, including hardware components and blockchain infrastructure, may be conducted to insure that the system is not compromised. Continuous monitoring for new threats and vulnerabilities in cryptographic algorithms and hardware security, as well as periodic updates to firmware and software components to address emerging security concerns, may be implemented as crucial steps of the process. Additionally, training programs for system operators will ensure proper use of security features and maintain awareness of potential threats.

Mass customization offers significant advantages over traditional mass production methods. Unlike traditional mass production processes, mass customization enables rapid changes between different artwork designs, substrates, blank products, printer settings, ink selection, etc., without the need to manually alter machinery or operational parameters. Due to the ever-accelerating business cycle, customers prefer to receive finished goods with customized images using the fastest possible methods.

Artists, image designers, and/or graphic work creators produce unique, fashionable, and culturally desirable works. Consumers wish to acquire goods with the works printed or formed thereon, creating opportunities to increase distribution while providing monetary incentives for artists and producers to publish their works. However, there is currently no satisfactory way to effectively reduce illegal copying of printed images and other material using digital imaging systems, and particularly when providing geographically separate imaging systems. This issue disincentivizes authors and creators from publishing their works digitally.

Digital security technologies, such as blockchain technologies with decentralized distributed immutable ledgers, are increasingly being applied to provide accurate record-keeping, information/transaction tracking, and digital theft protection. However, public network blockchain applications are typically complex to use, requiring high levels of computational capacity and involving expensive computation/mining fees and blockchain management. These applications are not focused on preventing the impermissible copying or appropriation of digital images, and previously known existing blockchain technologies do not provide sufficient incentives for artists and creators to publish their works digitally.

What is claimed:

1. A system for producing digitally imaged goods comprising:
a central computing device;
a plurality of geographically separated imaging systems, each geographically separated imaging system comprising a computing device and an associated digital imaging device, wherein at least one of the geographically separated imaging systems comprises a digital printer for printing ink comprising sublimation dye;
the central computing device constructed and arranged to select a geographically separated imaging system from the plurality of geographically separated imaging systems based upon properties of an image to be produced on a final substrate and a location and capability of the geographically separated imaging system to produce the image on the final substrate, wherein the digital image is encrypted with a key that is unique to the digital image and is associated with a private key assigned to the selected geographically separated computing system.

2. The system for producing digitally imaged goods of claim 1, wherein the central computing device is constructed to limit a number of an image produced by the geographically separated imaging systems.

3. The system for producing digitally imaged goods of claim 1, further comprising a blockchain-based ledger constructed to record transactions and quality control information transmitted between the central computing device and the geographically separated imaging systems.

4. The system for producing digitally imaged goods of claim 1, further comprising a digital imaging management gateway (DIMG) connecting the central computing device to the geographically separated imaging systems.

5. The system for producing digitally imaged goods of claim 1, wherein said each geographically separated imaging systems comprises a trusted platform module constructed for imaging device authentication and integrity verification.

6. The system for producing digitally imaged goods of claim 1, further comprising an integrated secure hardware module constructed to handle cryptographic payment authorization.

7. The system for producing digitally imaged goods of claim 1, further comprising Hardware Security Modules (HSMs) and Fast Identity Online (FIDO) authentication devices that verify and secure financial transactions during the production and ordering of goods.
